(19) United States
(12) Patent Application Publication
(10) Pub. No.: US 2010/0235605 A1
(43) Pub. Date: Sep. 16, 2010

(54) ENHANCEMENT OF STORAGE LIFE EXPECTANCY BY BAD BLOCK MANAGEMENT

(76) Inventors: Nir Perry, Holon (IL); Ori Moshe Stern, Modeen (IL); Eitan Mardiks, Raanana (IL); Yacov Duzly, Raanana (IL)

Correspondence Address: BRINKS HOFER GILSON & LIONE/SanDisk, P.O. BOX 10395, CHICAGO, IL, 60610, US

(21) Appl. No.: 12/706,504

(22) Filed: Feb. 16, 2010

Related U.S. Application Data
(60) Provisional application No. 61/207,555, filed on Feb. 13, 2009.

(51) Int. Cl. G06F 12/06

(52) U.S. Cl. 711/170; 711/E12.084

(57) ABSTRACT

A method and system are disclosed that permit a storage device to remain fully functional despite running out of a sufficient supply of spare blocks in memory. The storage device includes a non-volatile memory and a controller, where the controller is configured to detect an insufficiency of spare blocks and convert operative blocks to spare blocks. The method includes techniques for selecting certain operative blocks for conversion to spare blocks using the storage manager on the storage device and a file system manager that may or may not be part of the storage device.

### CROSS-REFERENCE TO RELATED APPLICATIONS

This application claims the benefit of U.S. Provisional App. No. 61/207,555 filed Feb. 13, 2009, the entirety of which is incorporated herein by reference.

### TECHNICAL FIELD

This application relates generally to managing data in a memory system. More specifically, this application relates to the operation of a memory system to allow for continued operations in re-programmable non-volatile semiconductor flash memory despite an accumulation of bad memory blocks.

### BACKGROUND

Non-volatile memory systems, such as flash memory, are used in digital computing systems as a means to store data and have been widely adopted for use in consumer products. Flash memory may be found in different forms, for example in the form of a portable memory card that can be carried between host devices or as a solid state disk (SSD) embedded in a host device. These memory systems typically work with data units called “blocks” that can be written, read and erased by a storage manager often residing in the memory system. Flash memory systems are typically marketed with a “declared capacity” that identifies a minimum amount of usable storage space available to a user. For example, the SanDisk Corporation produces microSD flash storage devices with a declared capacity of 2, 4, 8 and 16 gigabytes.

When a file system manager (FSM) supports a given storage device, the FSM learns the declared capacity and builds a table of addressable blocks that spans the range of blocks that make up the declared capacity. This range needs to be respected by both the FSM and the device. If there is a discrepancy between the actual range of the device and the range assumed by the FSM based on the declared capacity, data can be lost or parts of the storage device will be unused.

Due to physical processes well known in flash memory systems, blocks tend to fail and become useless over time. In non-flash memory systems, such as memory systems using magnetic media with physical to logical address translation, the FSM would be notified by the storage device of “bad sectors” and, as a result, the FSM marked the associated cluster as “bad” and wrote the data to an another physical location. With flash-based storage devices, where the host accesses logical blocks and not physical blocks, the management of bad storage areas has moved into the storage manager on the storage device and the FSM does not know about bad physical blocks or ever need to get involved in marking logical addresses as bad. As the FSM is not directly aware of the failure of a physical block, the storage manager of a storage device needs to replace the bad blocks. In general, flash memory systems are designed such that the storage manager maintains a number of spare blocks that are not visible to the FSM because they are not included in the declared capacity and are thus not part of the range of available blocks the FSM uses based on the declared capacity. When there is a need to replace a bad block, the storage manager replaces the physical address of the bad block with a physical address of a spare block and possibly copies data from the bad block into the spare block. This operation is transparent to the FSM.

A problem arises when the stock of spare blocks is exhausted, and there are no more spares to replace bad blocks. As the FSM expects to see the full range of available blocks, and as the storage device cannot deliver, the storage device cannot continue to serve the FSM in an ordinary way. Some vendors address this situation by declaring the storage device to be faulty once the spare blocks have run out and prevent any further use of the storage device. Other vendors switch the storage device into a “read only” mode, hiding from the FSM the fact that there are some writeable blocks. The FSM can then only retrieve the pre-written data from the storage device and back-up the written data to another storage device. The problem of spare block exhaustion can arise even if the storage device is almost empty, and the user will be disappointed and surprised to discover that nothing more can be written into that storage device. Thus, the storage device may have its ordinary life ended, even though most of the blocks in the storage device may be in perfect condition.

### BRIEF SUMMARY

In order to enable a user to continue and use a storage device after the original spare blocks are exhausted or fall below a minimum amount, a system and method for managing bad blocks is disclosed. The storage device may include a first set of blocks, defined as operative blocks, a second set of blocks defined as spare blocks and a mechanism for re-defining an operative block as a spare block.

According to a first aspect a storage device includes a non-volatile memory having a first set of physical blocks, defined as operative blocks, that are visible to a host of the non-volatile memory, and a second set of physical blocks, defined as spare blocks, that are hidden from the host of the non-volatile memory. The storage device also includes a controller in communication with the non-volatile memory, where the controller is configured to re-define operative blocks as spare blocks. The re-definition of operative blocks as spare blocks may be in response to detecting a shortage of spare blocks in the non-volatile memory or to a user request to increase performance by increasing a number of spare blocks. A shortage of spare blocks may be defined as the number of spare blocks below a predetermined threshold.

In a second aspect, a method for managing bad memory blocks in a storage device includes detecting a shortage of spare blocks in the non-volatile memory at a controller of the non-volatile memory and, in response to detecting a shortage of spare blocks, the controller re-defining an operative block as a spare block. The controller may redefine an operative block as a spare block by communicating with a file system manager to determine which operative block or blocks to convert to spare blocks. The determination of which operative blocks to convert may be based on a selection of the deepest operative blocks where the capacity of the storage device is recorded as reduced. The deepest block refers to the usable block that is the last operative block in the memory. Alternatively, the determination may be based on a selection by the file system manager (FSM) of clusters associated with blocks other than the deepest block where the FSM maintains the same addressable range but frees up operative blocks by either classifying clusters associated with operative blocks as bad or by creating a dummy file that is never accessed by the FSM.

In yet another aspect, a method of managing memory blocks is disclosed that permits a user to re-define operative blocks as spare blocks in a storage device even before the stock of spare blocks is exhausted. These additional spare blocks may be used by the storage manager of the storage device for improving performance or endurance of the storage device. The storage device may notify the host of one or more options for the number of spare blocks to be redefined as operative blocks, and the host may then inform the user. The storage device may also provide information to the user via the host regarding the performance benefits that may be achieved for each of the different options.

### BRIEF DESCRIPTION OF THE DRAWINGS

FIG. 1 illustrates a block diagram of a storage system and host according to one embodiment.

FIG. 2 illustrates a block diagram of an alternative embodiment of the storage system and host of FIG. 1.

FIG. 3 shows a simplified diagram of an implementation of block management.

FIG. 4 shows a simplified diagram of the phases of rehabilitating memory that has an insufficient number of spare blocks.

FIG. 5 shows a simplified diagram of another embodiment of the phases of rehabilitating memory that has an insufficient number of spare blocks.

FIG. 6 is a flow chart of a method of handling a memory that has run out of spare blocks.

FIG. 7 is a flow chart illustrating a method for implementing the rehabilitation phases of FIG. 4.

FIG. 8 is a flow chart illustrating an alternative method for implementing the rehabilitation phases of FIG. 4.

FIG. 9 is a flow chart illustrating a method for implementing the rehabilitation phases of FIG. 5.

### DETAILED DESCRIPTION

Although not intended to be limiting in any way, the following terms may be used in this document and may take the meaning provided below.

File System Manager (FSM)—circuitry, software, or a combination of circuitry and software that manages the file system. The FSM may be located on the host of a memory system, but optionally may be in the controller inside the storage device of a memory system.

Cluster—a unit of storage space allocation that the file system manages where a cluster may include one or more sectors.

Block—a unit of storage space that a storage device can manage, read from and write to. A block has one or more pages, where a page is the minimum unit of reading or writing. A block is an internal storage unit that translates into sectors and clusters from the FSM's point of view.

Operative block—a physical block that is currently accessible to the FSM through a group of logical addresses (clusters) referred to as a logical block.

Spare block—a physical block that is hidden by the storage manager from the FSM such that the spare block is not in the addressable logical space visible to the FSM. Spare blocks are kept in reserve by the storage manager and used to replace operative blocks that become unusable.

Bad block—bad blocks are blocks that have been found to be bad or unusable and marked as such so that they are unavailable to the FSM or the storage manager.

Bad cluster—a range of addresses (cluster) that the FSM designates as “bad”, despite not being associated with any defective blocks, so that the operative block or blocks associated with the clusters may be sacrificed for use as spare blocks by the storage device.

Declared Capacity—The storage capacity that is presented by the storage device to the FSM. This capacity is a commercial commitment of the storage vendor.

Deepest Block—the usable block which is the last operative block in the memory. This term is used, instead of the common term “highest block”, as the nomenclature of blocks can be such that the lowest numbered block is the last block.

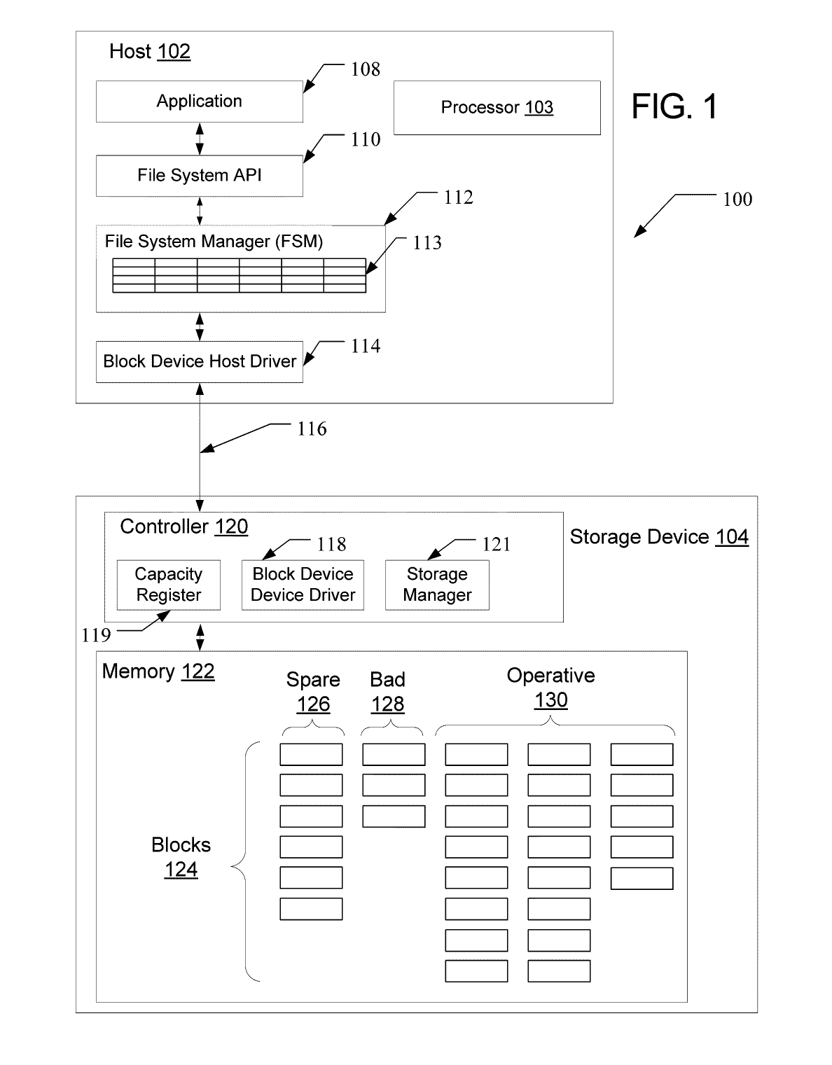

A non-volatile memory system 100 suitable for use in implementing aspects of the invention is shown in FIG. 1. A host 102 of FIG. 1 stores data into and retrieves data from a storage device 104. The storage device 104 may be flash memory embedded within the host, such as in the form of a solid-state disk (SSD) drive installed in a personal computer. Alternatively, the storage device 104 may be in the form of a card or a USB storage that is removably connected to the host 102 through a mechanical and electrical connector.

The host 102 of FIG. 1 may include a processor 103 that runs one or more application programs 108. The application programs 108, when data is to be stored on or retrieved from the storage device 104, communicate through a file system application programming interface (API) 110 with the file system manager (FSM) 112. The FSM 112 may be a software module executed on the processor 103 and manages the files in the storage device 104. The FSM 112 manages clusters of data 113 in logical address space. Common operations executed by a FSM 112 include operations to create, open, move, copy, and delete files. The FSM 112 may be circuitry, software, or a combination of circuitry and software. Accordingly, the FSM 112 may be a stand-alone chip or software executable by the processor of the host 102. A block device host driver 114 translates instructions from the FSM 112 for transmission over an interface 116 between the host 102 and storage device 104. The block device interface 116 may be any of a number of known interfaces, such as SD, MMC, USB storage device, SATA and SCSI interfaces.

A block device driver 118 executed by the controller 120 of the storage device 104 manages communication with the host 102 over the interface 116. The storage manager 121 executed by the controller 120 of the storage device 104 manages the blocks 124 in memory 122. The controller 120 may convert between logical addresses of data used by the FSM 112 and physical addresses of the memory 122 during data programming and reading. The memory 122 includes physical blocks 124 of flash memory that each consist of a group of pages, where a block 124 is a group of pages in a flash storage device and a page is a smallest unit of writing in the memory 122. The blocks 124 in the memory 122 include operative blocks 130 that are represented as logical blocks to the FSM 112. Some of the blocks 124 are bad blocks 128 that have been found to be bad or unusable and marked as such so that they are unavailable to the FSM 112. Others of the blocks 124 are spare blocks 126 that are not available to the FSM 112 and are used by the controller 120 to replace bad blocks 128. A capacity register 119 identifying a current capacity of the storage device 104 may be maintained in non-volatile memory within the controller 120.

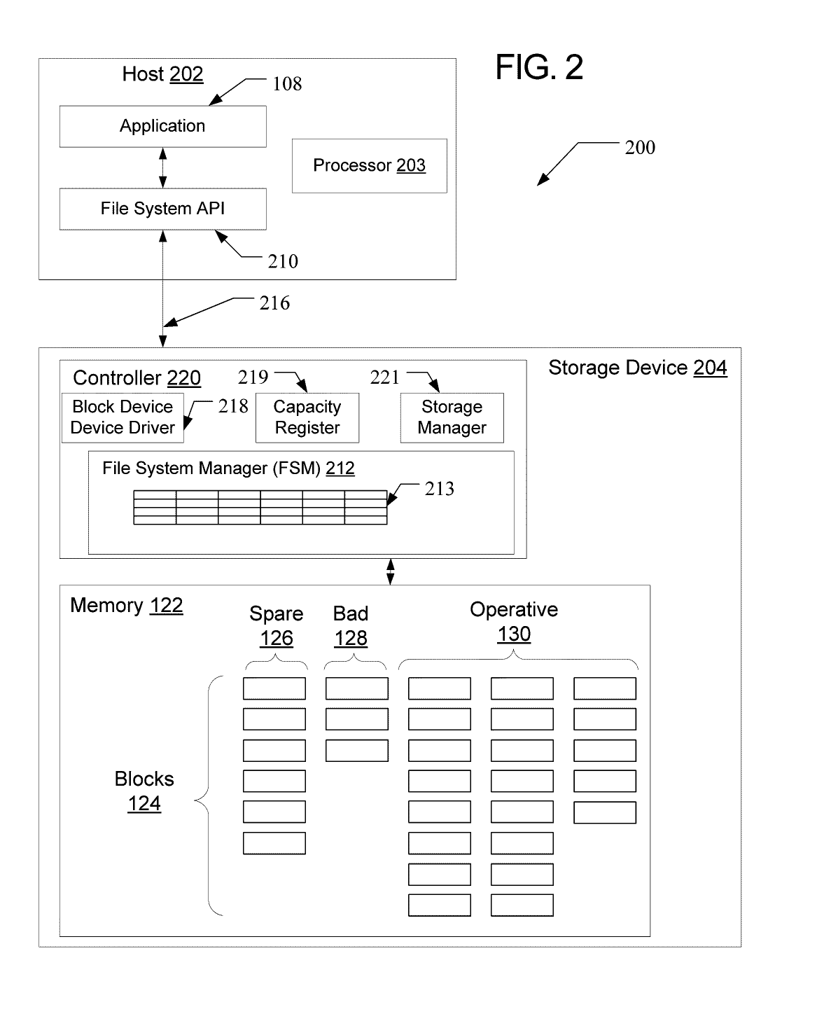

In another embodiment, as shown in FIG. 2, the non-volatile memory system 200 may be arranged with the FSM 212 in the storage device 204. As with the FSM in the host 102 of FIG. 1, the FSM 212 manages clusters of data 213 in logical address space. In this embodiment, a host 202 utilizes a file system API 210 that can communicate with the FSM 212 on the storage device over a file system interface 216, rather than a block device interface. Examples of suitable file system interfaces include SMB, NFS and Internet Protocol (IP) interfaces. The block device device driver 218 executed by the controller 220 of the storage device 204 manages communication between the FSM 212 and memory 122. A capacity register 219 identifying a current capacity of the storage device 204 may be maintained in non-volatile memory within the controller 220. The storage manager 221 executed by the controller 220 manages the blocks 124 in memory 122.

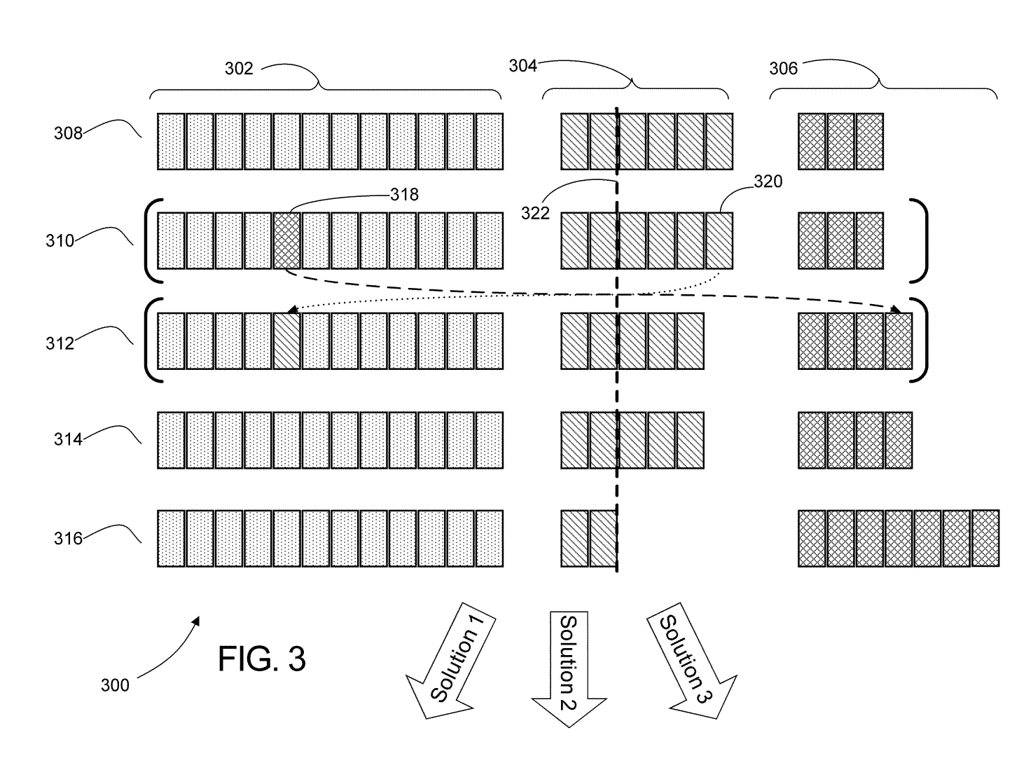

FIG. 3 shows a simplified conceptual diagram of a generic implementation of block management in a storage device. A non-volatile memory, such as flash memory, in the storage device 300 includes operative blocks 302, spare blocks 304 and bad blocks 306. A typical mass storage device, such as illustrated in FIGS. 1 and 2, has many blocks. Only a portion of the typical number of blocks found in these devices is shown in FIG. 3 for ease of illustration. Each horizontal layer in FIG. 3 shows a different phase 308, 310, 312, 314, 316 in the process of substituting a spare block 304 for a bad block 306. Phase 308 denotes an initial state where there are 12 operative blocks 302, 6 spare blocks 304 and 3 bad blocks 306 in the memory 300.

Phase 310 shows the state of the storage device 300 after some usage. During the time before phase 310 (not shown), erase cycles were performed on various blocks of the memory. As a result, some blocks are wearing out. Phase 310 occurs when the storage device 300 recognizes that block 318 has become a bad block that needs to be added to the list of bad blocks 306. In order to support the declared capacity of the storage device 300, the block 318, which has become a bad block and therefore unusable, should be replaced with one of the spare blocks 304. Phase 312 shows the state of the storage device 300 after adding block 318 to the list of bad blocks 306 and replacing block 318 with spare block 320. The process of replacing a bad block 306 with a spare block 318 may be accomplished by the storage manager, transparently to the file system manager, reassigning the physical address of the bad block to the spare block. Phase 314 shows the results of phases 310 and 312 where the number of spare blocks 304 is decreased by one and the number of bad blocks 306 is increased by one.

Line 322 in FIG. 3 is the representative of the minimum number of spare blocks required for operating the storage device. This minimum may differ for different types of devices and is shown as greater than two blocks in FIG. 3 by way of example only. Phase 316 shows the state of the storage device 300 after a period of time when the process of replacing bad blocks with spare blocks illustrated in phases 310 and 312 has been repeated enough times that the number of spare blocks 306 remaining is less than the predetermined minimum 322. When the storage device 300 has reached phase 316, a typical course of action would be for the storage device to declare itself as read only and prevent any further writing operations to the operative blocks 302.

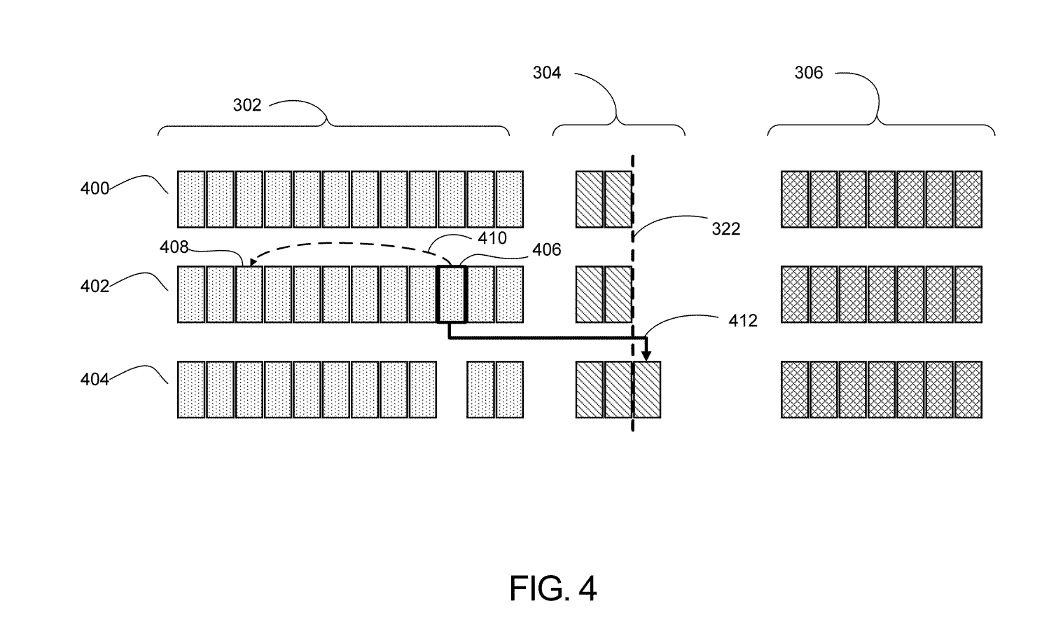

Referring now to FIG. 4, a simplified diagram of the phases 400, 402, 404 of a method for allowing the storage device 300 to extend its ability to function as writable storage is illustrated. Phase 400 starts at the state of storage device 300 in FIG. 3 (phase 316) where the number of spare blocks 304 is below the minimum 322 necessary for the storage device 300 to operate at its current declared capacity.

The storage device 300 first determines the number of missing spare blocks needed to bring the spare block count above the minimum 322. In this example, the storage device needs one spare block. The storage manager 121 reports to the FSM 112 that it needs one spare block. In one embodiment, where a communication protocol between FSM 112 and storage manager 121 may be implemented that allows the FSM 112 to be the sole initiator communication with the storage manager 121, the reporting can be done by way of the storage manager 121 setting a flag to modify the status of the next “write” command to tell the FSM 112 that there is an issue with the spare blocks, and that a dialog with the storage manager 121 is needed. Upon the next “write” command from the FSM 112, the storage manager 121 reports to the FSM 112 that there is a spare block shortage. Alternatively, the reporting by the storage manager 121 to the FSM 112 may be accomplished by way of a polling mechanism where the FSM 112 periodically checks with the storage manager 121 to see if more spare blocks are needed rather than only when a next write command is issued. In another embodiment, the storage manager 121 can interrupt the FSM 112 and then the FSM 112 reads the information from the storage manager 121. In another embodiment, both the storage manager 121 and the FSM 112 can initiate commands and the storage manager 121 can send a message to the FSM 112 identifying the required number of spare blocks.

Phase 402 shows the response of the FSM 112 to learning the number of spare blocks needed to bring the total number of spare blocks above the minimum level 322. Here, one block is needed to bring the total number above the minimum 322. The FSM 112, which manages the file system in terms of clusters in logical space, selects a number of clusters that correspond to the number of required blocks (equal or greater). In this example, one cluster is assumed to span an address range equal to a physical block so a one-to-one correlation exists between clusters and blocks. The FSM 112 selects one cluster that is shown in FIG. 4 as currently mapped to block 406. Also for this example, we assume that the selected cluster is associated with valid data. The FSM 112 then needs to move the data from block 406 to another cluster associated with a different block 408 in the operative blocks 302. The FSM 112 may select which different block 408 to move the valid data into based on any of a number of criteria and may vary based on the type of file system being used. After moving the data, which is represented in phase 402 by arrow 410, the FSM 112 notifies the storage manager 121 that the selected cluster originally associated with block 406 is no longer needed so that block 406 is available for use as a spare block.

In one embodiment, the FSM 112 marks the cluster associated with block 406 as a bad cluster in order to free up the block 406 for use as a spare block.

In another embodiment, the FSM 112 may instead create a dummy file, or add the cluster to an existing dummy file, that collects all the clusters the FSM 112 needs to free for the storage manager 121 in order to free up block 406. The storage manager 121 provides either the number of blocks and the size of a block to the FSM 112 or the required space in terms of known units, such as kilobytes or megabytes. The FSM 112 knows the size of a cluster and can determine the number of clusters required based on the size of a block and the number of blocks being requested or by the amount of space specified in known units. The data in the dummy file is not valid and the dummy file may be any necessary size.

Phase 404 shows the block arrangement in the storage device after it disconnects the physical block 406 from its logical address and adds (as shown by arrow 412) the operative block to the list of spare blocks 304. The number of spare blocks was increased by one as expected, and the ordinary operation of the storage device is rehabilitated such that data may still be written to the storage device. In the two embodiments discussed above with respect to FIG. 4, the deepest block of the operative blocks remains the same and the capacity register in the storage device is unchanged even though the effective capacity of the device has been reduced. Thus, the addressable address range of the device is the same from the perspective of the FSM 112, but the FSM 112 has itself removed clusters at one or more points within that range to allow operative blocks corresponding to those removed clusters to be re-tasked as spare blocks by the storage manager 121. The FSM 112 tracks the clusters it has labeled as “bad” or placed into dummy files by recording these addresses in a file system database, for example a file allocation table (FAT) table, that is stored in non-volatile memory on the storage device. The information on the FAT allows the storage device to be removed and used in its current rehabilitated (reduced capacity) form with another FSM 112 or host.

In another embodiment, a variation of the methods described above with respect to the phases of FIG. 4 may include a process that is executed by the storage manager 121 independently of the host and FSM 112. For example, the storage manager 121 may turn the storage device into a “read only” device when the number of spare blocks falls below the predetermined minimum setting of the storage device and look at the file system database, such as the FAT, for free clusters in operative blocks available to convert into spare blocks. In this embodiment, the storage device would modify the file system database and allocate a free block to be a spare block without involving the FSM 112. When the storage device is next powered off and on and the host refreshes the FAT, the rehabilitated storage device can resume normal operation (at a lower effective capacity because of the conversion of an operative block to a spare block).

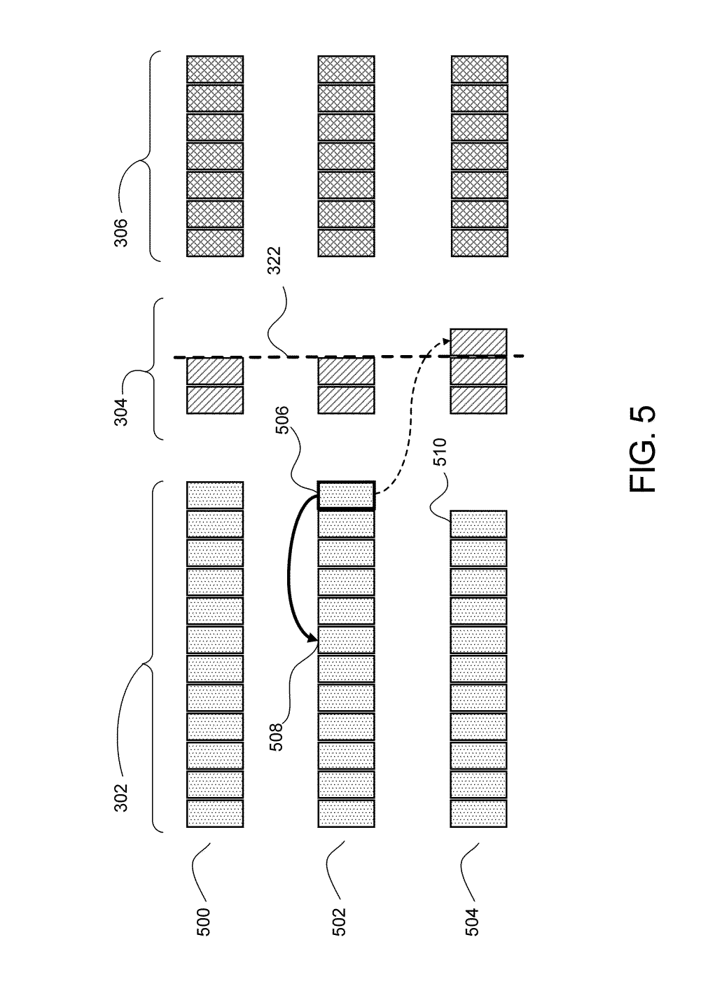

Attention is now called to FIG. 5, showing a simplified diagram of another embodiment for rehabilitating a storage device with a spare block supply 304 that has fallen below the minimum necessary for the device to operate at its current declared capacity. Phase 500 shows the state of the storage device 300 from FIG. 3 (phase 316) where the number of spare blocks 304 is below the minimum required for storage operation. The storage manager 121 determines the number of additional spare blocks 304 needed for its normal operation (i.e., needed to raise the spare block number above the minimum level 322). The storage manager 121 then notifies the FSM 112 of the requested reduction in capacity. In this example, only one block is necessary to raise the number of spare blocks above the minimum level 322 so the capacity is decreased by a size equivalent of one block. In phase 504, the FSM 112 moves any data from the deepest block 506 to block 508 in the operative blocks 302. Then, the FSM 112 indicates to the storage device that the declared capacity can be reduced to a new value that the storage manager 121 will stored in the capacity register.

Phase 504 shows the state where the memory changes the distance to the deepest block of the operative blocks 302 to be one less than the previous value and the number of spare blocks 304 is increased by one as requested. The new deepest block 510 is the block prior to the former deepest block 506. Note that an advantage of the embodiment of FIG. 5 over the embodiments described with respect to FIG. 4 is that the FSM 112 is relieved of any special handling of the block management such as storing dummy files or declaring clusters bad at one or more points in the address range and tracking these clusters in the FAT. In the embodiment of FIG. 5, everything is being done by and within the storage device, which simply takes the deepest block or blocks for use as spare blocks and resets the capacity register so that the FSM 112 will not even see these blocks. This embodiment can make it much simpler to port the rehabilitated “handicapped” device between FSMs.

As described herein, reference to the number of spare blocks decreasing below the minimum level is intended to mean that the number of spare blocks has decreased below the minimum level considered necessary for the device to permit write operations, typically preset by the manufacturer, such that rehabilitation is triggered. When rehabilitation is triggered and spare blocks are created from operative blocks in any of the embodiments discussed above, more than the minimum number of spare blocks may be created. The FSM and storage manager 121 may be configured to create more than just the minimum number of spare blocks to avoid the trigger. This hysteresis between the minimum and actual number of spare blocks may be useful if the process of rehabilitation is time or energy consuming. The rehabilitation process may be time and energy consuming if, for example, significant amounts of data needs to be moved out of the operative block selected for conversion to a spare block, to where it is desirable to create more than the minimum number of spare blocks to bring the number of spare blocks well beyond the minimum level so as to minimize the number of times that the storage device's operations are interrupted.

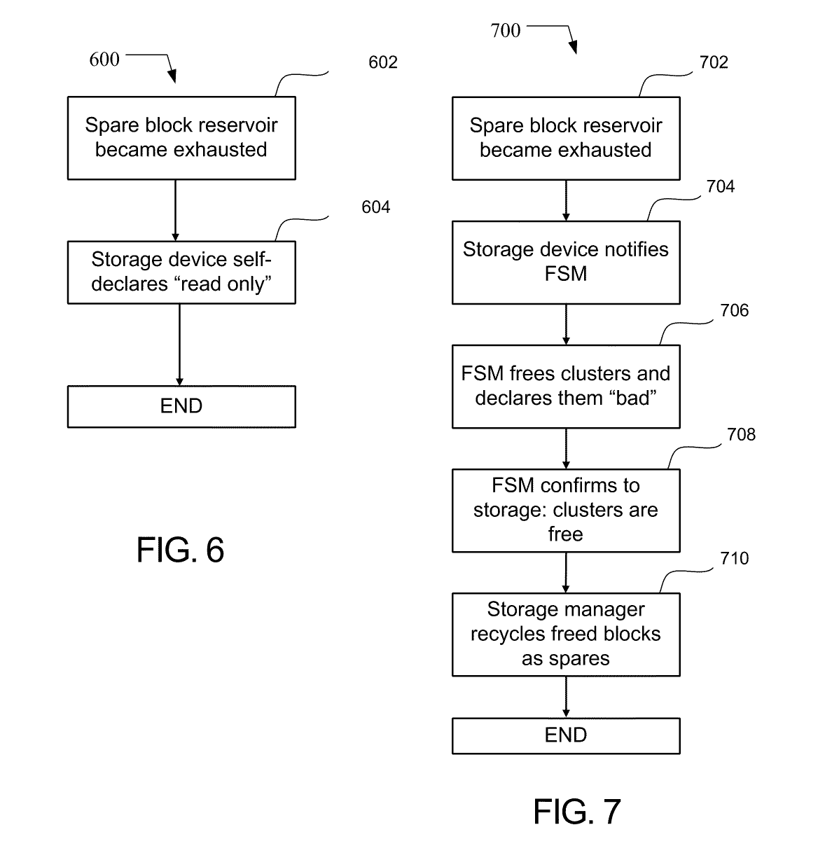

Referring now to FIG. 6, a flow chart is shown for one common approach 600 to handling exhaustion of the spare block supply that results from the process illustrated in FIG. 3. The storage device 300 recognizes that the spare block reservoir is exhausted to the point where any remaining supply of spare blocks 304 is less than the minimum required by the device (at 602). The storage device then declares itself to be a “read only” device, causing the FSM 112 to cease sending new data to be written (at 604).

FIG. 7 shows one method 700 for rehabilitating a storage device 300 corresponding to the process illustrated in FIG. 4 such that the storage device may continue to be used as for writing data. The storage device recognizes that the spare block reservoir is exhausted to the point where any remaining supply of spare blocks 304 is less than the minimum required by the device (at 702). The storage manager 121 notifies the FSM 112 of the need for more spare blocks (at 704). This reporting may be accomplished through one or more different mechanisms. For example, the notification may be accomplished by the storage manager 121 setting of a flag that the FSM 112 looks for on the next write command, may be via a periodic polling of the storage manager 121 by the FSM 112, or may be actively conveyed to the FSM 112 by the storage manager 121 by way of an interrupt command or other method. When the FSM 112 notices the special status report, it initiates a dialogue with the storage device to learn how many spare blocks are needed. The FSM 112 then frees the required number of operative blocks by moving clusters of data to empty operative blocks and marking the clusters that correspond to the freed blocks as “bad clusters” (at 706). Note that the labeling of clusters as “bad clusters” here is not in response to any awareness of, or information from the storage device regarding actual unusable/bad blocks or some device error regarding the clusters. Instead, what are otherwise valid and functional clusters are voluntarily marked by the FSM 112 as “bad clusters” to permit the storage manager 121 to use the physical block or blocks associated with the clusters as spare blocks. The FSM 112 then confirms to the storage manager 121 that the clusters are free, and the storage device recycles the corresponding operative blocks 302 into new spare blocks 306 (at 708, 710). The declared capacity remains the same because the range of addresses is not changed in the capacity register, but the actual capacity has now been reduced because the FSM 112 has sacrificed clusters within that range of addresses to allow the storage manager 121 to convert one or more operative blocks to spare blocks.

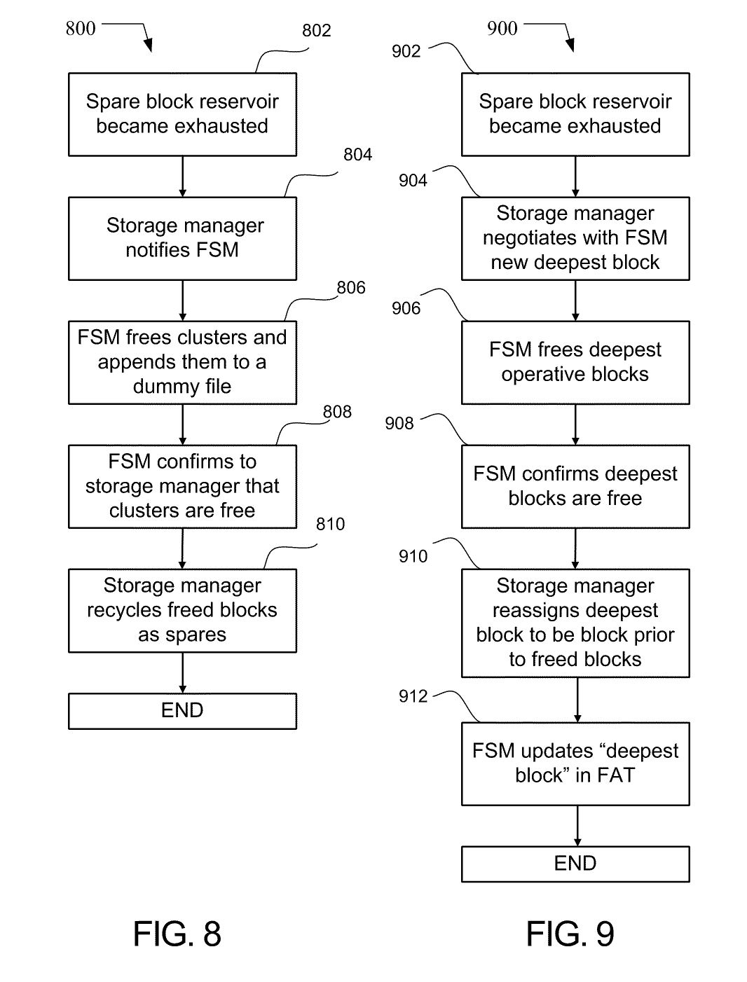

FIG. 8 shows another method 800 for rehabilitating a storage device 300 that also corresponds to the process illustrated in FIG. 4. The storage device recognizes that the spare block reservoir is exhausted to the point where any remaining supply of spare blocks 304 is less than the minimum required by the device (at 802). The storage manager 121 notifies the FSM 112 of the need for more spare blocks (at 804). As with the method of FIG. 7, this reporting may be accomplished through one of more different mechanisms, such as by the storage manager 121 setting of a flag that the FSM 112 looks for on the next write command, via a periodic polling of the storage manager 121 by the FSM 112, or may be actively conveyed to the FSM 112 by the storage manager 121 by way of an interrupt command or other method. When the FSM 112 notices the special status report, it initiates a dialogue with the storage device to learn how many spare blocks are needed. The FSM 112 then frees the required number of operative blocks by moving clusters of data to empty operative blocks and appending the clusters that correspond to the freed blocks to a dummy file that is never used by the FSM 112 (at 806). The dummy file can be a new file, just for the current session, or an existing file that is appended in every session. The FSM 112 then confirms to the storage manager 121 that the clusters are free, and the storage device recycles the corresponding operative blocks 302 into new spare blocks 306 (at 808, 810). As in the embodiment of FIG. 7, the declared capacity remains the same because the range of addresses is not changed in the capacity register, but the actual capacity has now been reduced because the FSM 112 has sacrificed clusters to allow the storage manager 121 to convert one or more operative blocks to spare blocks.

FIG. 9 shows another method 900 for rehabilitating a storage device 300 that corresponds to the process illustrated in FIG. 5. The storage device recognizes that the spare block reservoir is exhausted to the point where any remaining supply of spare blocks 304 is less than the minimum 322 required by the device (at 902). The storage manager 121 notifies the FSM 112 that there is a need for more spare blocks and negotiates with the FSM 112 for more spare blocks (at 904). The notification may be accomplished by the storage manager 121 setting a flag to modify the status of the next “write” command to tell the FSM 112 that there is an issue with the spare blocks, and that a dialog with the device is needed. Upon the next “write” command, the storage manager 121 reports to the FSM 112 that there is a spare block shortage and what the new deepest block needs to be to bring the spare block pool up to a desired level. As with the methods of FIGS. 6 and 7, this reporting may alternatively be accomplished through one of more different mechanisms, such via a periodic polling of the storage manager 121 by the FSM 112, or by the storage manager 121 actively conveying the information to the FSM 112 by way of an interrupt command or other method.

When the FSM 112 notices the special status report, it initiates a dialogue with the storage device to learn how many spare blocks are needed. The FSM 112 then frees the required number of operative blocks, starting from the deepest operative block working its way backwards, by moving clusters of data to empty operative blocks 302 (at 906). The FSM 112 then confirms to the storage manager 121 that the clusters are free and that the address of the deepest block can be modified (at 908). The storage manager 121 then changes the address of the deepest block (see 508 in FIG. 5) backwards (i.e. reduces the declared capacity of the storage device), converting all the freed blocks into spares (at 910). Then the FSM 112 updates the address of the deepest block in the file allocation table (FAT) (at 912). Additionally, part or all of the above procedure can be done internally by the storage device itself, by manipulating blocks so that free blocks are converted to spare blocks and by updating the file system tables accordingly. In another embodiment, the process of the storage manager 121 in the controller notifying the FSM 112 regarding spare block status, for any of the methods of FIGS. 7-9, may include the storage manager 121 providing information to the FSM 112 on the absolute number of spare blocks currently available, or simply an indication of a relative number of spare blocks currently available (e.g., low, medium or high). This information on an absolute number of spare blocks may be provided in conjunction with or in place of information on a number of operative blocks that the storage manager 121 would like released as spare blocks.

In the discussion above, although reference is made to the FSM and storage manager arrangement of FIG. 1 for ease of discussion, all of the embodiments described above are equally applicable to either the configuration of FIG. 1, with the FSM 112 located in the host 102 and separate from the storage device 104, or the implementation of FIG. 2, where the FSM 212 is part of the storage device 204 itself.

In another implementation, there may be times when there end up being more operative blocks re-defined as spare blocks than are actually necessary. For example, the storage manager may have requested a default number of additional spare blocks to replenish the spare block supply and provide a buffer beyond the minimum number required based on a presumed rate of failure of operative blocks. If the storage manager later notes that the rate of replacement is lower than first assumed, it may release some of the spare blocks that were converted from operative blocks back to being operative blocks. This re-tasking of a spare block to an operative block, where the spare block was a previously re-tasked operative block, may be implemented for those spare blocks that that were previously obtained from operative blocks using the any of the methods of FIGS. 7-9.

It should be noted that the variations of the embodiments described above can be used to rehabilitate a storage device even if the FSM is very simple and cannot cooperate with the storage device as described above. For example, rehabilitation of a storage device with too few spare blocks is possible if a storage device having a storage manager configured to execute one of the embodiments is a memory card used in a camera or a digital recorder that cannot carry out the role of the FSM as described.

In such cases, the storage device will behave as a typical storage device, and when the reservoir of spare blocks is exhausted, it may implement one of the following variations of the methods of FIGS. 7-9. In this situation, until the storage device is powered off, any attempt to write into it will result in an error message. However, if the storage device is equipped with a storage manager 121 incorporating the any of the embodiments of FIGS. 7-9, the storage device can be rehabilitated by inserting it in a computer with an FSM having the capabilities discussed above, and conduct a special recovery reformatting process, as described below.

When doing a recovery formatting, the computer backs up the contents of the storage device, reformats the storage device (it is assumed that the bad blocks will remain bad blocks through the reformatting, so that the storage device is reformatted with an insufficient number of spare blocks), and an application on the computer may handle a user interface to interact with the user to ask the user how much they wish to increase the spare block reservoir. The storage manager sends information to the computer regarding the minimal required amount of spare blocks needed for rehabilitation. In addition, optionally, it can also send the computer a recommendation for a larger number of spare blocks for performance improvements, where performance is considered improved by increasing the spare block level. The computer will accept a response from the user and interact with the FSM and storage manager to achieve the changes authorized by the user. The storage manager will apply the method of FIG. 7, 8 or 9 as noted above to achieve the requested spare block level.

In an embodiment where the storage manager incorporates the method of FIG. 9, the storage manager may apply the requested spare block count without asking the FSM to free operative blocks since the user input already instructs the storage manager. This step will move the minimum spare block level, decrease the number of operative blocks, and increase the number of spare blocks. The storage device will then update the capacity register 119 in the storage device 104 that holds the information about the current capacity of the device. This register may be in non-volatile memory in the controller 120 or the flash memory 122 depending on the type of storage device. For example, in the SD protocol, this is the CSD register.

After reconfiguring the memory card as indicated above, it will be recognized in a host with a simple FSM, such as the digital camera mentioned above, and the camera will either know what the declared volume of the device is (if the deepest block is changed as in the implementation of FIG. 9) or know that certain clusters are now unavailable because they are listed as bad or in dummy files (if the implementations of FIG. 7 or 8 are used by the FSM of the computer that rehabilitates the storage device) and use the information accordingly. After returning the rehabilitated card to the simple FSM, the user should not be allowed to re-format the storage device since the information regarding the “bad” clusters or the dummy files will be lost.

In yet other embodiments, a storage device 104 may be configured to permit adjustment of the amount of spare blocks 126 to enhance performance even before the stock of spare blocks 126 is exhausted. In other words, a user of a new storage device may insert the device into a computer and be presented with a performance table that will allow the user to select a performance level for the device that correlates to a number of spare blocks to be maintained. Generally, increasing the number of spare blocks may improve performance of a storage device, for example, extra spare blocks may be used to create or increase the size of a memory cache in the storage device.

In another embodiment, there may be instances where the storage manager determines that it has converted more operative blocks to spare blocks than it really needed. In this situation, the storage manager may permit the additional spare blocks (that were previously operative blocks) to be converted back into operative blocks. These particular blocks released for use as operative blocks by the storage manager changing the declared capacity in the capacity register of the storage device so that the deepest block is increased and the FSM can now see that it has more addressable operative blocks. After the device has been in use for a time and more spare blocks may be needed to remain functional, the storage device can then increase the number of spare blocks by converting operative blocks 130 to spare blocks 126, decreasing usable capacity in any of the ways described above. By increasing or decreasing the number of spare blocks from the original value that the vendor has provided, the user can customize the trade-off between the capacity and the life expectancy of the storage device.

In this embodiment, where the number of extra spare blocks may be reduced by releasing spare blocks that were previously operative blocks, the FSM may present the user with a single recommendation for a performance improvement level, a group of incremental improvement levels or a combination of the two. The user may select an option and that option is relayed via the host user input device to the storage device for implementing as described.

A system and method for managing bad blocks to extend the life of a storage device as been disclosed. A storage device is capable of changing its declared capacity from a fixed, given capacity to a dynamic capacity that decreases with time, giving the FSM and the user the option to continue operating with the reduced capacity. In one embodiment, a procedure for changing the declared capacity of the storage device includes, upon detection of shortage in spare blocks, the storage device determining the available capacity, reserving a predefined number of spare blocks, and notifying the FSM. The FSM, in turn, shuffles data inside the storage device to release a number of blocks at the end of the storage device and indicates to the storage device that these blocks can be released. Then the storage device turns these blocks into new spare blocks and decreases the deepest block.

In another embodiment, upon detection of a shortage in spare blocks the storage device determines the number of missing spare blocks and reports this number to the FSM. The FSM may select a number of clusters that cover the required amount of blocks and marks these clusters as bad clusters. Once the FSM declares these “sacrificed” blocks as bad clusters and notifies the storage device, the storage device disconnects the corresponding physical blocks from their logical addresses, and adds these physical blocks to the list of spare blocks. In this implementation the deepest block is not changed.

In another embodiment, upon detection of shortage in spare blocks, the storage device determines the number of missing spare blocks and reports this number to the FSM. The FSM selects a number of clusters that cover the required amount of blocks and generates a new dummy file that consists of these clusters. By creating this dummy file and leaving it in the storage forever, the FSM confiscates the corresponding blocks from further use. The FSM then notifies the storage device that these blocks can be released, and the storage device then releases the corresponding physical blocks and adds them to the list of spare blocks. Note that in this implementation, as in the previous one, the highest block count (position of the deepest block) is not changed. Instead of creating a new dummy file each time the storage device asks for a rehabilitation of the spare block list, the FSM can add the clusters to an existing, appendable dummy file. Also, as noted above, in other implementations the storage manager can operate to re-define operative blocks as spare blocks without interacting with an FSM.

It is therefore intended that the foregoing detailed description be regarded as illustrative rather than limiting, and that it be understood that it is the following claims, including all equivalents, that are intended to define the spirit and scope of this invention.

What is claimed is:

1. A storage device comprising:
a non-volatile memory, the non-volatile memory having:
a first set of physical blocks, defined as operative blocks, that are visible to a host of the non-volatile memory; and
a second set of physical blocks, defined as spare blocks, that are hidden from a host of the non-volatile memory;
and
a controller in communication with the non-volatile memory, the controller configured to re-define operative blocks as spare blocks.

2. The storage device of claim 1, wherein the controller is configured to redefine operative blocks as spare blocks in response to detecting a shortage of spare blocks in the non-volatile memory.

3. The storage device of claim 1, wherein the controller is configured to redefine operative blocks as spare blocks in response to a host command.

4. The storage device of claim 1, wherein the controller is configured to redefine operative blocks as spare blocks in response to receiving a user request to enhance performance of the storage device when a number of spare blocks in the storage device already exceeds a predetermined minimum.

5. The storage device of claim 1, wherein the controller is configured to redefine operative blocks as spare blocks by:
notifying a file system manager (FSM) of the shortage of spare blocks;
receiving instructions from the FSM identifying at least one operative block to release for use as a spare block;
and
converting the at least one operative block identified by the FSM to a spare block.

6. The storage device of claim 5, wherein the instructions from the FSM identify a deepest operative block in the operative blocks and wherein the controller is further configured to:
receive an acknowledgement from the FSM that data was transferred from the deepest operative block to one or more other operative blocks; and
notify the FSM that an operative block sequentially preceding the deepest operative block is a new deepest block, wherein a capacity of the storage device is reduced.

7. The storage device of claim 6, further comprising a capacity register, wherein the controller is configured to update the capacity register to indicate that the capacity of the storage device has been reduced when at least one operative block is converted to a spare block.

8. The storage device of claim 5, wherein the instructions from the FSM identify one or more clusters corresponding to a operative block other than a deepest operative block, the operative block containing no valid data and wherein the controller is configured to convert the operative block other than the deepest operative block to a spare block.

9. The storage device of claim 5, wherein the FSM is positioned within the storage device.

10. The storage device of claim 5, wherein the FSM is positioned in a host that is in communication with the storage device.

11. The storage device of claim 5, wherein the controller is further configured to notify the FSM of a total number of spare blocks remaining in the storage device.

12. A method of managing bad memory blocks comprising:
in a storage device having a controller and a non-volatile memory including a first set of physical blocks comprising operative blocks visible to a host of the non-volatile memory and a second set of physical blocks comprising spare blocks hidden from the host of the non-volatile memory:
detecting a shortage of spare blocks in the non-volatile memory at a controller of the non-volatile memory; and
in response to detecting the shortage of spare blocks, the controller re-defining an operative block as a spare block.

13. The method of claim 12, wherein re-defining the operative block as the spare block comprises redefining an amount of operative blocks as spare blocks sufficient to provide at least a minimum amount of spare blocks necessary for the storage device to function as a writable storage device.

14. The method of claim 13, wherein the controller determines the amount of spare blocks necessary for the storage device to function as a writable storage device and redefines operative blocks as spare blocks without interacting with a file system manager (FSM).

15. The method of claim 14, wherein the storage device redefines operative blocks as spare blocks by changing a location of a deepest block and storing information on the location of the deepest block in a capacity register.

16. The method of claim 13, wherein redefining operative blocks as spare blocks comprises reducing a number of operative blocks and increasing a number of spare blocks, whereby a capacity of the storage device is reduced.

17. The method of claim 12, wherein reducing the number of operative blocks and increasing the number of spare blocks comprises the controller:
notifying a file system manager (FSM) of the shortage of spare blocks;
receiving instructions from the FSM identifying at least one operative block to release for use as a spare block;
and
converting the at least one operative block identified by the FSM to a spare block.

18. The method of claim 17, wherein the instructions from the FSM identify a deepest operative block in the operative blocks and wherein the controller:
transfers data from the deepest operative block to one or more other operative blocks; and
notifies the FSM that an operative block sequentially preceding the deepest operative block is a new deepest block, wherein a capacity of the storage device is reduced.

19. The method of claim 18, wherein the controller updates a capacity register on the storage device to indicate that the capacity of the storage device has been reduced when at least one operative block is converted to a spare block.

20. The method of claim 17, wherein the instructions from the FSM identify one or more clusters corresponding to an operative block other than a deepest operative block, the operative block containing no valid data and wherein the controller is converts the operative block other than the deepest operative block to a spare block.

21. The method of claim 17, wherein the FSM is positioned within the storage device.

22. A method of managing memory blocks to permit user selection of storage device performance comprising:
in a storage device having a controller and a non-volatile memory including a first set of physical blocks comprising operative blocks visible to a host of the non-volatile memory and a second set of physical blocks comprising spare blocks hidden from the host of the non-volatile memory, the controller:
receiving an inquiry from the host regarding a performance level of the storage device;
transmitting to the host a performance level option; and
converting a number of operative blocks to spare blocks in response to receiving a host selection of the performance level.
